(19) United States
(12) Patent Application Publication
(10) Pub. No.: US 2026/0326722 A1
(43) Pub. Date: Oct. 22, 2026

(54) INTELLIGENT VEHICLE WASHING AND WIPING DEVICE

(71) Applicants: SHAANXI ANGCHEJUN ELECTRONIC TECHNOLOGY CO., LTD, Shaanxi (CN); Shaanxi Embedded Ruirong Industrial Technology Co., Ltd., Shaanxi (CN)

(72) Inventor: Jingwei ZHANG, Shaanxi (CN)

(73) Assignees: SHAANXI ANGCHEJUN ELECTRONIC TECHNOLOGY CO., LTD, Shaanxi (CN); Shaanxi Embedded Ruirong Industrial Technology Co., Ltd., Shaanxi (CN)

(21) Appl. No.: 19/378,217

(22) Filed: Nov. 3, 2025

(30) Foreign Application Priority Data
Apr. 16, 2025 (CN) 202510477841.X

(51) Int. Cl. B60S 3/00

(52) U.S. Cl. CPC B60S 3/002

(57) ABSTRACT

An intelligent vehicle washing and wiping device is provided and includes a mobile chassis with a column provided thereon; and a vehicle body wiping mechanism including a reversing plate, a cloth bag, a fan and a reversing drive member. The reversing plate is horizontally disposed on a side of the column. The cloth bag is connected with a bottom surface of the reversing plate. The fan is disposed on the reversing plate. An air outlet of the fan is in communication with the cloth bag. The fan is configured to blow air into the cloth bag to inflate the cloth bag. The reversing drive member is disposed on the column. The reversing drive member is connected with the reversing plate. The reversing drive member is configured to drive the reversing plate to rotate so as to alter a wiping surface of the cloth bag.

### CROSS-REFERENCE TO RELATED APPLICATION

This patent application claims the benefit and priority of Chinese Patent Application No. 202510477841.X, entitled “INTELLIGENT VEHICLE WASHING AND WIPING DEVICE” filed on Apr. 16, 2025, the disclosure of which is incorporated by reference herein in its entirety as part of the present application.

### TECHNICAL FIELD

The present disclosure relates to the field of automotive cleaning equipment, and in particular to an intelligent vehicle washing and wiping device.

### BACKGROUND

With economic development and social progress, more and more people own vehicles, which need to be regularly cleaned and maintained. Vehicle owners usually have their vehicles cleaned at a specialized vehicle wash and maintenance shop for cleaning, or use an automatic vehicle washing machine provided at a gas station for free cleaning. However, some owners prefer to wash their vehicles manually by themselves. Regardless of whether manual or automatic equipment is used for vehicle washing, the final procedure involves wiping the vehicle body.

At present, manual wiping remains the dominant method after vehicle washing, and some intelligent unmanned vehicle washing machines are equipped with blowing mechanisms to dry the vehicle. However, in an actual vehicle drying process of using the blowing mechanism, multiple visible water streaks often remain on the vehicle body, resulting in an unsatisfactory cleaning effect. Manual wiping is still required to remove these water streaks, making it difficult to fully automate the vehicle wiping process.

### SUMMARY

The present disclosure proposes an intelligent vehicle washing and wiping device to solve the above-described deficiencies in the conventional technology. The intelligent vehicle washing and wiping device can automatically perform a wiping operation on a vehicle, and prevents the appearance of water streaks.

A technical solution of the present disclosure is as follows. An intelligent vehicle washing and wiping device includes:
a mobile chassis, where a column is disposed on the mobile chassis; and
a vehicle body wiping mechanism including a reversing plate, a cloth bag, a fan and a reversing drive member; where the reversing plate is horizontally disposed on a side of the column, the cloth bag is connected with a bottom surface of the reversing plate, the fan is disposed on the reversing plate, an air outlet of the fan is in communication with the cloth bag, and the fan is configured with blow air into the cloth bag to inflate the cloth bag; and the reversing drive member is disposed on the column, the reversing drive member is connected with the reversing plate, and the reversing drive member is configured to drive the reversing plate to rotate so as to change a wiping surface of the cloth bag.

In at least one embodiment of the present disclosure, the reversing plate is further provided with a wringing mechanism which includes a wringing rotary rod, a slip ring and a wringing motor. The wringing rotary rod is longitudinally rotatably connected with a bottom of the reversing plate. The wringing rotary rod is located in the cloth bag, the slip ring is fitted around the wringing rotary rod. The slip ring is longitudinally slidably connected with the wringing rotary rod. An inner bottom of the cloth bag is connected with the slip ring. The wringing motor is disposed on the reversing plate, and a rotating shaft of the wringing motor is connected with the wringing rotary rod.

In at least one embodiment of the present disclosure, the column is provided with a linkage mechanism which includes a first mounting plate, a second mounting plate and two regulating motors. The first mounting plate is horizontally disposed on a top of the column. The first mounting plate is hinged to the column. The second mounting plate is horizontally disposed on the first mounting plate. The second mounting plate is hinged to the first mounting plate. The two regulating motors are respectively disposed on the column and the first mounting plate. Rotating shafts of the two regulating motors are respectively connected with the first mounting plate and the second mounting plate. The reversing drive member is disposed on the second mounting plate.

In at least one embodiment of the present disclosure, the reversing plate is a regular triangular plate, and a top of the cloth bag is connected with a bottom periphery of the reversing plate.

In at least one embodiment of the present disclosure, the second mounting plate is vertically provided with a third mounting plate. A roof wiping mechanism is horizontally disposed on the third mounting plate. The roof wiping mechanism has a same structure as the vehicle body wiping mechanism, and the cloth bag of the roof wiping mechanism is horizontally disposed.

In at least one embodiment of the present disclosure, three sliding grooves are uniformly distributed in a circumferential direction of the wringing rotary rod, each of the three sliding grooves extends along a length direction of the wringing rotary rod, and an inner wall of the slip ring is provided with three sliders, the three sliders are respectively embedded into the three sliding grooves.

In at least one embodiment of the present disclosure, a longitudinal projection of the vehicle body wiping mechanism and a longitudinal projection of the roof wiping mechanism are offset from the mobile chassis.

In at least one embodiment of the present disclosure, a horizontal plate is provided at a top end of the column, the first mounting plate is hinged above the horizontal plate, and the second mounting plate is hinged above the first mounting plate. The first mounting plate and the second mounting plate have the same size.

Compared with the conventional technology, the embodiments have the following beneficial effects.
1. In the embodiments, by providing a mobile chassis with a column and a wiping mechanism including a reversing plate, a cloth bag, a fan and a reversing drive member, in the process of wiping a vehicle, the cloth bag is inflated by the fan, then the wiping mechanism of the device is moved via the mobile chassis, such that the inflated cloth bag is closely attached to a vehicle body around the vehicle for wiping; in the process of wiping the vehicle body, the reversing plate may be rotated by the reversing drive member such that the reversing plate drives the cloth bag to rotate, thereby switching wiping surfaces of the cloth bag. Compared with the conventional technology, the intelligent vehicle washing and wiping device is different from the manner in which the vehicle body is dried by means of a blowing mechanism, and through direct contact between the vehicle body and the cloth bag inflated by the fan, water streaks are prevented from forming on the vehicle body, no manual cleaning is required, and the entire device is driven to move around the vehicle body via the mobile chassis, which truly achieves automated wiping of the vehicle body.
2. In the embodiments, a wringing rotary rod is rotatably connected with the cloth bag at a bottom end of the reversing plate, and a slip ring connected with a bottom end of the cloth bag is longitudinally slidably connected with the wringing rotary rod; and under the action of a wringing motor, by activating the wringing motor to drive the wringing rotary rod to rotate, the cloth bag is gradually wound around the wringing rotary rod, while the slip ring slides over the wringing rotary rod, and finally the cloth bag is tightly wound around the wringing rotary rod to achieve the purpose of wringing out moisture from the cloth bag.
3. In the embodiments, a linkage mechanism including a first mounting plate, a second mounting plate and two regulating motors are provided. In the process of using the device to wipe the vehicle body, the cloth bag may be quickly fine-tuned by the linkage mechanism to always maintain close contact with the vehicle body, thus ensuring the cleaning quality for the vehicle.
4. In the embodiments, a third mounting plate is disposed on the second mounting plate, and a roof wiping mechanism having the same structure as the vehicle body wiping mechanism is disposed on the third mounting plate. In the process of using the device to wipe the vehicle body, the same principle as the vehicle body wiping mechanism enables the wiping operation of the roof to be performed simultaneously, thereby further improving the wiping efficiency of the vehicle while ensuring the cleaning quality.

### BRIEF DESCRIPTION OF THE DRAWINGS

FIG. 1 shows a schematic structural diagram of a whole-vehicle wiping mechanism according to the present disclosure;

FIG. 2 shows a schematic structural diagram of a vehicle body wiping mechanism according to the present disclosure;

FIG. 3 shows a schematic structural diagram of a linkage mechanism according to the present disclosure;

FIG. 4 shows a partially schematic structural diagram of a vehicle body wiping mechanism according to the present disclosure; and

FIG. 5 shows a schematic structural diagram of a wringing rotary rod and a slip ring according to the present disclosure.

### LIST OF THE REFERENCE CHARACTERS

1 mobile chassis; 11 column; 2 vehicle body wiping mechanism; 21 reversing plate; 22 cloth bag; 23 fan; 24 reversing drive member; 3 wringing mechanism; 31 wringing rotary rod; 311 sliding groove; 32 slip ring; 321 slider; 33 wringing motor; 4 linkage mechanism; 41 first mounting plate; 42 second mounting plate; 43 regulating motor; 5 third mounting plate; 6 roof wiping mechanism.

### DETAILED DESCRIPTION OF THE EMBODIMENTS

The drawings in the present disclosure are not drawn strictly to the actual scale, and specific dimensions and the number of various structures may be determined according to actual needs. The drawings described in the present disclosure are only schematic structural diagrams.

In order to make the objects, technical solutions and advantages of the embodiments of the present disclosure clearer, the technical solutions in the embodiments of the present disclosure will be clearly and completely described below in conjunction with the drawings in the embodiments of the present disclosure. Apparently, the described embodiments are merely some, rather than all of the embodiments of the present disclosure. Based on the embodiments in the present disclosure, all the other embodiments that would have been obtained by those of ordinary skill in the art without any inventive effort shall fall within the scope of protection of the present disclosure.

Unless defined otherwise, the technical or scientific terms used in the present disclosure shall have the common meanings as understood by those of ordinary skill in the art to which the present disclosure belongs. The term “first”, “second” and other similar terms used in the present disclosure do not mean any order, quantity or importance, but are merely used to distinguish different components. The word “comprise” or “include” and other similar words mean that the element or object appearing before the word covers the element or object listed after the word and its equivalents, without excluding other elements or objects. The terms “inner”, “outer”, “upper”, “lower”, “far”, “near”, “front”, “rear” and the like are used only to denote relative positional relationships, and when an absolute position of the described object changes, the relative positional relationship may also change accordingly.

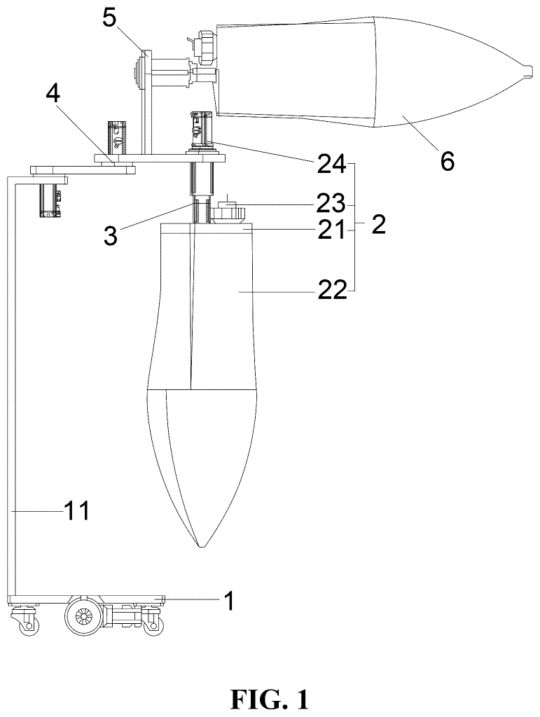

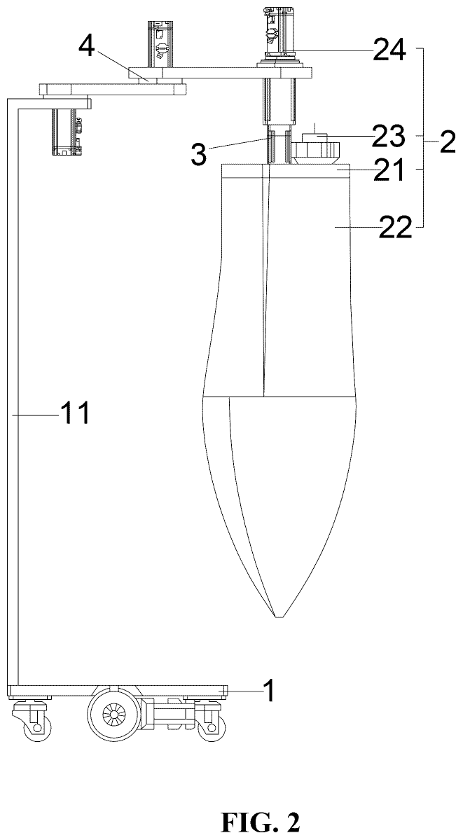

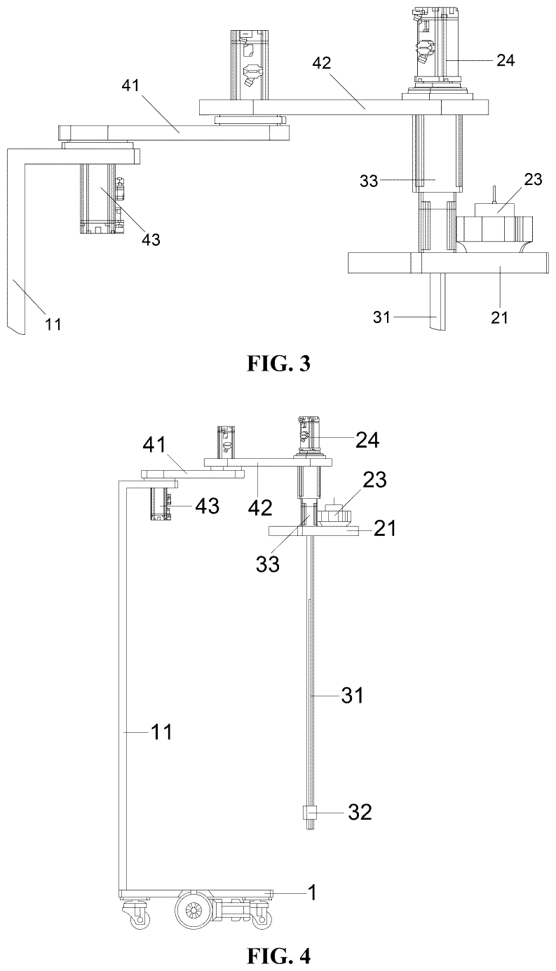

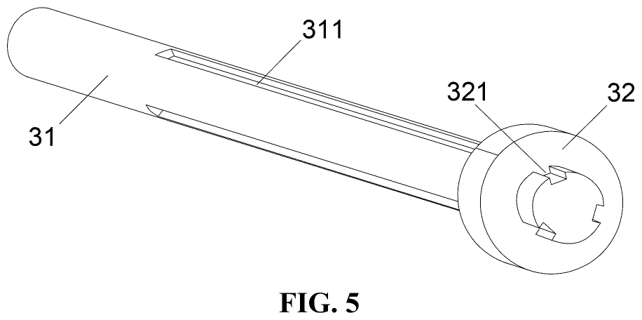

In conjunction with FIG. 1 to FIG. 5, an intelligent vehicle washing and wiping device includes:
a mobile chassis 1, where a column 11 is disposed on the mobile chassis 1, and the mobile chassis 1 is configured to drive the device to move; and
a vehicle body wiping mechanism 2 including a reversing plate 21, a cloth bag 22, a fan 23 and a reversing drive member 24; where the reversing plate 21 is horizontally disposed on a side of the column 11, the cloth bag 22 is connected with a bottom surface of the reversing plate 21, the fan 23 is disposed on the reversing plate 21, an air outlet of the fan 23 is in communication with the cloth bag 22, and the fan 23 is configured to blow air into the cloth bag 22 to inflate the cloth bag 22; and the reversing drive member 24 is disposed on the column 11, the reversing drive member 24 is connected with the reversing plate 21, and the reversing drive member 24 is configured to drive the reversing plate 21 to rotate so as to change a wiping surface of the cloth bag 22.

As an alternative embodiment, the reversing plate 21 is further provided with a wringing mechanism 3. The wringing mechanism 3 includes a wringing rotary rod 31, a slip ring 32 and a wringing motor 33. The wringing rotary rod 31 is longitudinally rotatably connected with the bottom of the reversing plate 21. The wringing rotary rod 31 is located in the cloth bag 22. The slip ring 32 is sleeved on the wringing rotary rod 31. The slip ring 32 is longitudinally slidably connected with the wringing rotary rod 31. An inner bottom of the cloth bag 22 is connected with the slip ring 32. The wringing motor 33 is disposed on the reversing plate 21. A rotating shaft of the wringing motor 33 is connected with the wringing rotary rod 31. By activating the wringing motor 33 to drive the wringing rotary rod 31 to rotate, the cloth bag 22 is gradually wound around the wringing rotary rod 31, while the slip ring 32 slides over the wringing rotary rod 31, and finally the cloth bag 22 is tightly wound around the wringing rotary rod 31 to achieve the purpose of wringing out moisture from the cloth bag 22.

As an alternative embodiment, the column 11 is provided with a linkage mechanism 4. The linkage mechanism 4 includes a first mounting plate 41, a second mounting plate 42 and two regulating motors 43. The first mounting plate 41 is horizontally disposed on the top of the column 11. The first mounting plate 41 is hinged to the column 11. The second mounting plate 42 is horizontally disposed on the first mounting plate 41. The second mounting plate 42 is hinged to the first mounting plate 41. The two regulating motors 43 are respectively disposed on the column 11 and the first mounting plate 41. Rotating shafts of the two regulating motors 43 are respectively connected with the first mounting plate 41 and the second mounting plate 42. The reversing drive member 24 is disposed on the second mounting plate 42.

As an alternative embodiment, the reversing plate 21 is a regular triangular plate, and the top of the cloth bag 22 is connected with a bottom periphery of the reversing plate 21. The regular triangular reversing plate 21 is able to divide the cloth bag 22 into three wiping surfaces to make areas of the three wiping surfaces of the cloth bag 22 uniform.

As an alternative embodiment, the second mounting plate 42 is vertically provided with a third mounting plate 5. A roof wiping mechanism 6 is horizontally disposed on the third mounting plate 5. The roof wiping mechanism 6 has the same structure as the vehicle body wiping mechanism 2. The cloth bag 22 of the roof wiping mechanism 6 is horizontally disposed. In the process of using the device to wipe the vehicle body, the same principle as the vehicle body wiping mechanism 2 enables the wiping operation of the roof to be performed simultaneously, thereby improving the wiping efficiency of the vehicle while ensuring the cleaning quality.

As an alternative embodiment, the three sliding grooves 311 are uniformly distributed in a circumferential direction of the wringing rotary rod 31, each of the three sliding grooves 311 extends along a length direction of the wringing rotary rod 31, and an inner wall of the slip ring 32 is provided with three sliders 321. The three sliders 321 is respectively embedded into the three sliding grooves 311. The arrangement of the sliding grooves 311 on the wringing rotary rod 31 and the three sliders 321 on the slip ring 32 allows the slip ring 32 to slide in the length direction of the wringing rotary rod 31, but not to rotate in the circumferential direction of the wringing rotary rod 31.

As an alternative embodiment, a longitudinal projection of the vehicle body wiping mechanism 2 and a longitudinal projection of the roof wiping mechanism 6 are offset from the mobile chassis 1, and the above configuration prevents water squeezed out from the cloth bag 22 of the vehicle body wiping mechanism 2 and the roof wiping mechanism 6 during the wringing process from dripping directly onto the mobile chassis 1, thereby avoiding failures of the mobile chassis 1 caused by long-term exposure to water.

As an alternative embodiment, a horizontal plate is provided at a top end of the column 11, and the first mounting plate 41 is hinged above the horizontal plate to ensure that the column 11 has a platform which is sufficient to support the first mounting plate 41, thereby ensuring the structural stability of the device; and the second mounting plate 42 is hinged above the first mounting plate 41, such that the first mounting plate 41 can provide a sufficient support force to the second mounting plate 42, thus the second mounting plate 42 is sufficient to stably support the entire vehicle body wiping mechanism 2 and the roof wiping mechanism 6.

The working principle and method of use of the present embodiment is as follows.

The present disclosure proposes an intelligent vehicle washing and wiping device. When the intelligent vehicle washing and wiping device is to be used, before a vehicle is wiped, the fan 23 is first activated, and the cloth bag 22 is inflated with the fan 23, causing the cloth bag 22 to expand; then the whole device is moved by controlling the mobile chassis 1, such that the vertically arranged cloth bag 22 is brought into engagement with the side of the vehicle and the horizontally arranged cloth bag 22 is brought into engagement with the top of the vehicle, and the entire device is subsequently driven to move around the circumference of the vehicle via the mobile chassis 1, thereby completing the wiping operation for the vehicle. In the process of wiping the vehicle body by the device, by controlling the deflection of the first mounting plate 41 and the second mounting plate 42 via the two regulating motors 43, the cloth bag 22 may be quickly fine-tuned to always maintain close contact with the vehicle body, thus ensuring the cleaning quality for the vehicle. At the same time, when a moisture content of the cloth bag 22 is too large, the device is moved to a drain area via the mobile chassis 1, then the fan 23 is turned off, and the wringing motor 33 is activated to drive the wringing rotary rod 31 to rotate, such that the cloth bag 22 is gradually wound on the wringing rotary rod 31. Meanwhile, the slip ring 32 slides on the wringing rotary rod 31, and finally the cloth bag 22 is tightly wound on the wringing rotary rod 31, thus completing a wringing operation for the cloth bag 22, and ensuring that the wiping operation for the vehicle can be carried out quickly.

The above embodiments are merely specific implementations of the present disclosure and are intended to explain rather than limit the technical solutions of the present disclosure, and the scope of protection of the present disclosure is not limited herein. Although the present disclosure has been described in detail with reference to the foregoing embodiments, those skilled in the art should understand that any modifications or variations on the technical solutions of the foregoing embodiments may still be readily figured out by persons skilled in the art within the technical scope of the present disclosure, or some of the technical features therein may be equivalently replaced; furthermore, these modifications, variations or replacements do not make the essence of the corresponding technical solution depart from the spirit and scope of the technical solution of the embodiment of the present disclosure, and shall be covered by the scope of protection of the present disclosure.

1. An intelligent vehicle washing and wiping device, comprising:
a mobile chassis (1), wherein a column (11) is disposed on the mobile chassis (1); and
a vehicle body wiping mechanism (2) comprising a reversing plate (21), a cloth bag (22), a fan (23) and a reversing drive member (24);
wherein
the reversing plate (21) is horizontally disposed on a side of the column (11), the cloth bag (22) is connected with a bottom surface of the reversing plate (21), the fan (23) is disposed on the reversing plate (21), an air outlet of the fan (23) is in communication with the cloth bag (22), and the fan (23) is configured to blow air into the cloth bag (22) to inflate the cloth bag (22); and
the reversing drive member (24) is disposed on the column (11), the reversing drive member (24) is connected with the reversing plate (21), and the reversing drive member (24) is configured to drive the reversing plate (21) to rotate so as to change a wiping surface of the cloth bag (22).

2. The intelligent vehicle washing and wiping device as claimed in claim 1, wherein the reversing plate (21) is further provided with a wringing mechanism (3), and the wringing mechanism (3) comprises a wringing rotary rod (31), a slip ring (32) and a wringing motor (33), wherein the wringing rotary rod (31) is longitudinally rotatably connected with a bottom of the reversing plate (21), the wringing rotary rod (31) is located in the cloth bag (22), the slip ring (32) is sleeved on the wringing rotary rod (31), the slip ring (32) is longitudinally slidably connected with the wringing rotary rod (31), an inner bottom of the cloth bag (22) is connected with the slip ring (32), the wringing motor (33) is disposed on the reversing plate (21), and a rotating shaft of the wringing motor (33) is connected with the wringing rotary rod (31).

3. The intelligent vehicle washing and wiping device as claimed in claim 1, wherein the column (11) is provided with a linkage mechanism (4), and the linkage mechanism (4) comprises a first mounting plate (41), a second mounting plate (42) and two regulating motors (43), wherein the first mounting plate (41) is horizontally disposed on a top of the column (11), the first mounting plate (41) is hinged to the column (11), the second mounting plate (42) is horizontally disposed on the first mounting plate (41), the second mounting plate is hinged to the first mounting plate (41), the two regulating motors (43) are respectively disposed on the column (11) and the first mounting plate (41), and rotating shafts of the two regulating motors (43) are respectively connected with the first mounting plate (41) and the second mounting plate (42); and the reversing drive member (24) is disposed on the second mounting plate (42).

4. The intelligent vehicle washing and wiping device as claimed in claim 1, wherein the reversing plate (21) is a regular triangular plate, and a top of the cloth bag (22) is connected with a bottom periphery of the reversing plate (21).

5. The intelligent vehicle washing and wiping device as claimed in claim 3, wherein the second mounting plate (42) is vertically provided with a third mounting plate (5), a roof wiping mechanism (6) is disposed on the third mounting plate (5), the roof wiping mechanism (6) has a same structure as the vehicle body wiping mechanism (2), and the cloth bag (22) of the roof wiping mechanism (6) is horizontally disposed.

6. The intelligent vehicle washing and wiping device as claimed in claim 2, wherein three sliding grooves (311) are uniformly distributed in a circumferential direction of the wringing rotary rod (31), each of the three sliding grooves (311) extends along a length direction of the wringing rotary rod (31), and an inner wall of the slip ring (32) is provided with three sliders (321), the three sliders (321) are respectively embedded into the three sliding grooves (311).

7. The intelligent vehicle washing and wiping device as claimed in claim 5, wherein a longitudinal projection of the vehicle body wiping mechanism (2) and a longitudinal projection of the roof wiping mechanism (6) are offset from the mobile chassis (1).

8. The intelligent vehicle washing and wiping device as claimed in claim 3, wherein a horizontal plate is provided at a top end of the column (11), the first mounting plate (41) is hinged above the horizontal plate, and the second mounting plate is hinged above the first mounting plate (41).
